(19) United States
(12) Patent Application Publication
(10) Pub. No.: US 2014/0080013 A1
(43) Pub. Date: Mar. 20, 2014

(54) METAL-AIR BATTERY

(71) Applicants: Xiaochuan Lu, Richland, WA (US); John P. Lemmon, Kennewick, WA (US); Guosheng Li, Richland, WA (US); Vincent L. Sprenkle, Richland, WA (US)

(72) Inventors: Xiaochuan Lu, Richland, WA (US); John P. Lemmon, Kennewick, WA (US); Guosheng Li, Richland, WA (US); Vincent L. Sprenkle, Richland, WA (US)

(73) Assignee: BATTELLE MEMORIAL INSTITUTE, Richland, WA (US)

(21) Appl. No.: 13/621,350

(22) Filed: Sep. 17, 2012

(51) Int. Cl. H01M 8/22

(52) U.S. Cl. 429/405

(57) ABSTRACT

A metal-air battery is disclosed. The battery includes a sodium anode and an air cathode. The battery further includes a solid electrolyte. The sodium anode may be a molten sodium anode, and the solid electrolyte may be a beta alumina solid electrolyte. The battery has an operating temperature between 100° C. and 200° C.

### STATEMENT REGARDING FEDERALLY SPONSORED RESEARCH OR DEVELOPMENT

The invention was made with Government support under Contract DE-AC05-76RLO1830, awarded by the U.S. Department of Energy. The Government has certain rights in the invention.

### TECHNICAL FIELD

This invention relates to a battery. More specifically, this invention relates to a medium temperature battery utilizing a sodium anode, an air cathode, and a solid electrolyte.

### BACKGROUND OF THE INVENTION

The current trend of carbon monetization brings out the need for effective, clean electrical storage. As such, electrochemical energy storage is considered by utility industries and the U.S. Department of Energy as a key enabler for the future smart electrical grid—a decentralized, custom interactive one that integrates significant levels of renewables and hybrid plug-in vehicles.

However, current electrochemical energy storage technologies, including sodium beta-alumina solid electrolyte (BASE) batteries are not yet capable and are also economically unviable for these applications. A key challenge that must be met to enable mass penetration of sodium BASE batteries into grid based markets is related to the ability to store high energy and simultaneously respond to power management needs that requires an immediate response to changes of electrical grids.

Current sodium metal chloride technology utilizes a combination of nickel and iron metal particles as the cathode material. The large cathode thickness in the tubular design requires a considerable excess of metal particles that are utilized as an electron transport path to the cathode current collector. This excess leads to a loss in energy capacity and results in an increased cost of the cell. Plus, degradation and performance issues caused by the growth of the metal halide during cycling needs to be addressed.

What is needed is the development of a new air cathode with optimized microstructure and composition to improve charge transfer and degradation mechanisms.

### SUMMARY OF THE INVENTION

In one embodiment of the present invention, a metal-air battery is disclosed. The battery includes a sodium anode. The battery further includes an air cathode. The battery also includes a solid electrolyte, and has an operating temperature between 100° C. and 200° C.

In one embodiment, the sodium anode is a molten sodium anode, and the solid electrolyte is a beta alumina solid electrolyte.

In one embodiment, the air cathode includes carbon, a catalyst, and a catholyte. The catalyst may be a metal or a metal oxide. The metal is, but not limited to, at least one of the following: Pt, Pd, Ag, and Au. The metal oxide may be MnO₂.

In one embodiment, the catholyte is an organic solvent plus a sodium salt or is an ionic liquid plus a sodium salt. The organic solvent is, but not limited to, at least one of the following: organic carbonates, such as ethylene carbonate, propylene carbonate, and dimethyl carbonate, ethers, such as etrahydrofuran and dioxolane, esters, and glymes. The ionic liquid is, but not limited to, at least one of the following: -ethyl-3-methylimidazolium bis(trifluoromethylsulfonyl)imide, 1-butyl-3-methylimidazolium bis(trifluoromethylsulfonyl)imide, 1-butyl-1-methylpyrrolinium bis(trifluoromethylsulfonyl)imide, and 1-butyl-1-methylpiperidinium bis(trifluoromethylsulfonyl)imide.

The sodium salt is, but not limited to, at least one of the following: NaBr, NaI, NaPF₆, and NaSO₃CF₃.

In another embodiment of the present invention, a metal-air battery is disclosed. The battery includes a molten sodium anode; and an air cathode. The battery has an operating temperature between 100° C. and 200° C.

### BRIEF DESCRIPTION OF THE DRAWINGS

FIG. 1 illustrates a metal-air battery, in accordance with one embodiment of the present invention.

FIG. 2 shows a discharge and charge curve during first cycle for the metal-air battery of FIG. 1.

FIG. 3 shows cell capacity fade over 10 cycles for the metal-air battery of FIG. 1.

### DETAILED DESCRIPTION OF THE PREFERRED EMBODIMENTS

The present invention is directed to a medium temperature battery having a sodium anode and an air cathode. The metal-air battery, which is rechargeable, includes a solid electrolyte and may be used for grid applications.

Unique properties of the invention include, but are not limited to, the following. The cathode active material, e.g. air, is not stored in the battery. Instead, air from the environment is used. The air is electrochemically reduced by catalytic surface sites inside the air electrode, forming either an oxide or peroxide ion that further reacts with cationic species in the cathode. The metal-air battery of the present invention is also attractive because of the low material cost and availability. Further, the metal-air battery separates a sodium anode and air cathode and allows sodium ion transport between the electrodes during charging and discharging. The battery is operated at intermediate temperatures to achieve adequate electrochemical performance for both the electrolyte and electrodes.

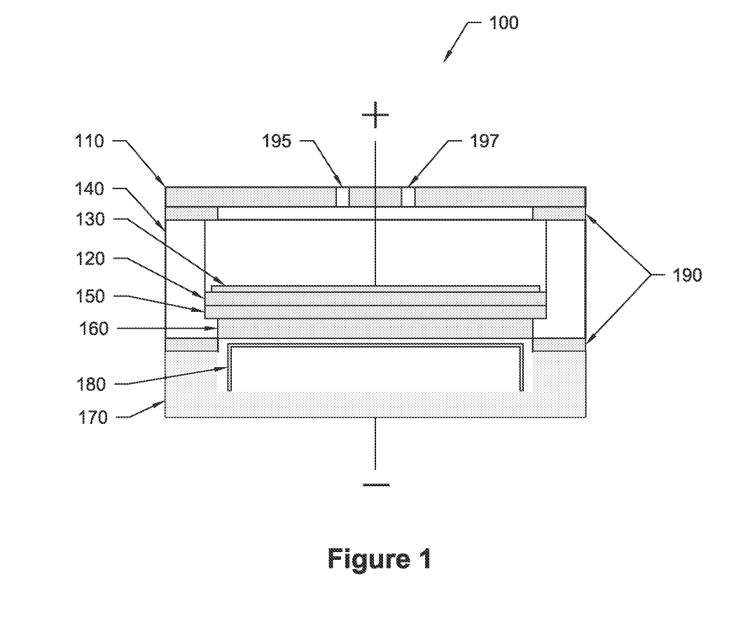

FIG. 1 illustrates a metal-air battery 100, in accordance with one embodiment of the present invention. The battery 100 includes an inlet 195 for pulling air in to the battery 100 from the environment and an exhaust outlet 197 for moving air out of the battery 100. Cathode end plate 110 and anode end plate 170 are at opposing ends of the battery 100 and compressed to an alumina ring 140 with alumina washers 190. The battery 100 further includes an air cathode 120, a sodium anode 160, and a solid electrolyte 150. The battery 100 has an operating temperature between approximately 100° C. and approximately 200° C.

In one embodiment, copper wool is used for the sodium anode 160. In one embodiment, the solid electrolyte 150 is a beta alumina solid electrolyte, and the sodium anode 160 is a molten sodium anode.

Still referring to FIG. 1, a metal shim 180 is coupled to the anode end plate 170. The metal shim 180 holds the copper wool which, as mentioned, is used for the sodium anode 160. A wire mesh 130 is coupled to the air cathode 120 as current collector. In one embodiment, the wire mesh 130 is a molybdenum (Mo) mesh.

The air cathode 120 may include carbon, a catalyst, and a catholyte. The catalyst may be a metal or a metal oxide. The metal is, but not limited to, at least one of the following: Pt, Pd, Ag, and Au. The metal oxide is, but not limited to, MnO₂.

In one embodiment, the catholyte may be an organic solvent plus a sodium salt or an ionic liquid plus a sodium salt. The organic solvent is, but not limited to, at least one of the following: organic carbonates, ethers, esters, and glymes. The organic carbonates are, but not limited to, ethylene carbonate, propylene carbonate, and dimethyl carbonate. The ethers are, but not limited to, etrahydrofuran and dioxolane. The ionic liquid is, but not limited to, at least one of the following: 1-ethyl-3-methylimidazolium bis(trifluoromethylsulfonyl)imide, 1-butyl-3-methylimidazolium bis(trifluoromethylsulfonyl)imide, 1-butyl-1-mthylpyrrolinium bis(trifluoromethylsulfonyl)imide, and 1-butyl-1-methylpiperidinium bis(trifluoromethylsulfonyl)imide.

The sodium salt is, but not limited to, at least one of the following: NaBr, NaI, NaPF₆, and NaSO₃CF₃.

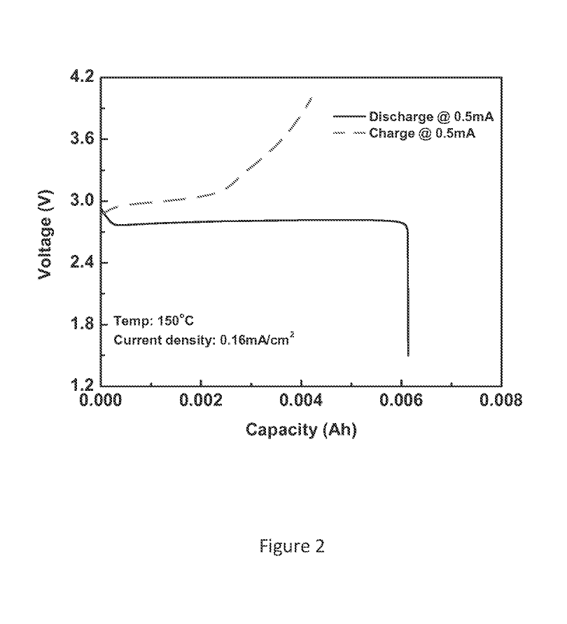

FIG. 2 shows a discharge and charge curve during first cycle for the metal-air battery of FIG. 1. The battery is operated at about 150° C. with a current density of about 0.16 mA/cm². As shown in FIG. 2, the battery has a first cycle charge capacity of about 4.0 mAh/g and a first cycle discharge capacity of about 6.0 mAh/g.

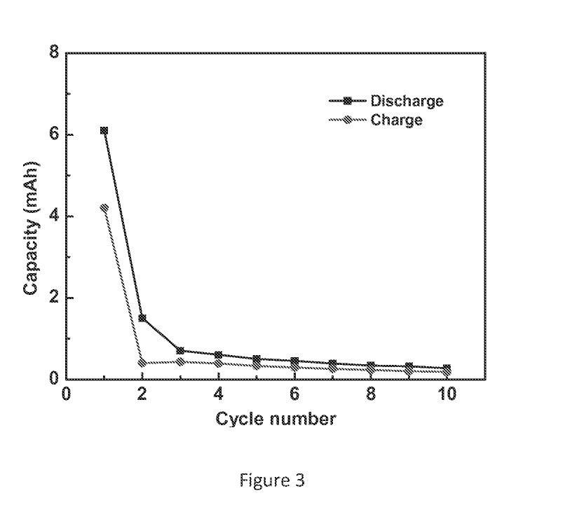

FIG. 3 shows cell capacity fade over 10 cycles for the metal-air battery of FIG. 1. As in FIG. 2, the battery has a first cycle charge capacity of about 4.0 mAh/g and a first cycle discharge capacity of about 6.0 mAh/g.

Significant performance fade was observed after the first cycle, as shown in FIG. 3. Post-test analysis indicated that NaCl instead of Na₂O was likely the main product during discharging. Na⁺ reacted with Cl⁻ in the catholyte to form NaCl during discharging.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

1. A metal-air battery comprising:
a. a liquid sodium anode;
b. an air cathode; and
c. a solid electrolyte,
wherein the battery has an operating temperature between 100° C. and 200° C., and wherein the metal-air battery is a sodium metal-air battery.

2. The metal-air battery of claim 1 wherein the sodium anode is a molten sodium anode.

3. The metal-air battery of claim 1 wherein the solid electrolyte is a beta alumina solid electrolyte.

4. The metal-air battery of claim 1 wherein the air cathode includes carbon, a catalyst, and a catholyte.

5. The metal-air battery of claim 4 wherein the catalyst is a metal or a metal oxide.

6. The metal-air battery of claim 5 wherein the metal is at least one of the following: Pt, Pd, Ag, and Au.

7. The metal-air battery of claim 5 wherein the metal oxide is MnO₂.

8. The metal-air battery of claim 4 wherein the catholyte is an organic solvent plus a sodium salt or an ionic liquid plus a sodium salt.

9. The metal-air battery of claim 8 wherein the organic solvent is at least one of the following: organic carbonates, ethers, esters, and glymes.

10. The metal-air battery of claim 9 wherein the organic carbonates comprise at least one of the following: ethylene carbonate, propylene carbonate, and dimethyl carbonate.

11. The metal-air battery of claim 9 wherein the ethers comprises at least one of the following: etrahydrofuran and dioxolane.

12. The metal-air battery of claim 8 wherein the ionic liquid is at least one of the following: 1-ethyl-3-methylimidazolium bis(trifluoromethylsulfonyl)imide, 1-butyl-3-methylimidazolium bis(trifluoromethylsulfonyl)imide, 1-butyl-1-methylpyrrolinium bis(trifluoromethylsulfonyl)imide, and 1-butyl-1-methylpiperidinium bis (trifluoromethylsulfonyl)imide.

13. The metal-air battery of claim 8 wherein the sodium salt is at least one of the following: NaBr, NaI, NaPF₆, and NaSO₃CF₃.

14. A metal-air battery comprising:
a. a molten sodium anode; and
b. an air cathode,
wherein the battery has an operating temperature between 100° C. and 200° C., and wherein the metal-air battery is a sodium metal-air battery.

15. The metal-air battery of claim 14 further comprising a solid electrolyte.

16. The metal-air battery of claim 15 wherein the solid electrolyte is a beta alumina solid electrolyte.

17. The metal-air battery of claim 14 wherein the air cathode includes carbon, a catalyst and a catholyte.

18. The metal-air battery of claim 17 wherein the catalyst is a metal or a metal oxide.

19. The metal-air battery of claim 18 wherein the metal is at least one of the following: Pt, Pd, Ag, and Au.

20. The metal-air battery of claim 18 wherein the metal oxide is MnO₂.

21. The metal-air battery of claim 17 wherein the catholyte is an organic solvent plus a sodium salt or an ionic liquid plus a sodium salt.

22. The metal-air battery of claim 21 wherein the organic solvent is at least one of the following: organic carbonates, ethers, esters, and glymes.

23. The metal-air battery of claim 22 wherein the organic carbonates comprise at least one of the following: ethylene carbonate, propylene carbonate, and dimethyl carbonate.

24. The metal-air battery of claim 22 wherein the ethers comprise at least one of the following: etrahydrofuran and dioxolane.

25. The metal-air battery of claim 21 wherein the ionic liquid is at least one of the following: 1-ethyl-3-methylimidazolium bis(trifluoromethylsulfonyl)imide, 1-butyl-3-methylimidazolium bis(trifluoromethylsulfonyl)imide, 1-butyl-1-methylpyrrolinium bis(trifluoromethylsulfonyl)imide, and 1-butyl-1-methylpiperidinium bis (trifluoromethylsulfonyl) imide.

26. The metal-air battery of claim 21 wherein the sodium salt is at least one of the following: NaBr, NaI, NaPF₆, and NaSO₃CF₃.

27. A metal-air battery comprising:
a. a liquid sodium anode;
b. an air cathode, wherein the air cathode includes carbon, a catalyst, and a catholyte; and
c. a beta alumina solid electrolyte;
wherein the battery has an operating temperature between 100° C. and 200° C., and wherein the catholyte is an organic solvent plus a sodium salt or an ionic liquid plus a sodium salt, and wherein the metal-air battery is a sodium metal-air battery, and the electrolyte does not contain an organic solvent.

28. The metal-air battery of claim 27 wherein the catalyst is a metal or a metal oxide.

29. The metal-air battery of claim 28 wherein the metal oxide is MnO₂.
